(19) United States
(12) Patent Application Publication
(10) Pub. No.: US 2012/0105440 A1
(43) Pub. Date: May 3, 2012

(54) Augmented Reality System

(76) Inventors: Stevan H. Lieberman, Silver Spring, MD (US); Charles Christopher, Salt Lake City, UT (US)

(21) Appl. No.: 13/168,686

(22) Filed: Jun. 24, 2011

Related U.S. Application Data
(60) Provisional application No. 61/358,766, filed on Jun. 25, 2010.

(51) Int. Cl. G09G 5/377; G06T 15/00

(52) U.S. Cl. 345/419; 345/633

(57) ABSTRACT

User created, maintained, and managed spatially coordinated and aware virtual data association system allowing any type of information to be associated to any item of location in the real world and associated viewing methods.

### CONTINUITY DATA

This is a non-provisional utility application of provisional patent application No. 61/358,766 filed on Jun. 25, 2010, and priority is claimed thereto.

### FIELD OF THE INVENTION

The present concerns augmented reality (AR), and more specifically, the present invention is a method for making personalizing AR on a computer device.

### BACKGROUND OF THE INVENTION

Electronic devices with efficient data entry interfaces (keyboards, touch pads, etc.) have become standard, as have high fidelity display systems, as well as real-time connections to world wide networks, be it private (LANs and WANs) or public (the “Internet”). Devices are also now more position aware (through integrated GPS as well and cell tower triangulation, and more recently WiFi access point triangulation) and have powerful data processing abilities from which to determine their location (even to the point of image/object recognition). Utilizing ubiquitous electronic devices' reliable and robust ability to determine location, and “high bandwidth” interfaces and network connections, a user can now—although previously impossible—record information associated with locations, and make this information sharable with others.

The concept of an augmented view/reality is known. AR has long been a wish of many people, and there are numerous such systems coming to the market. However, none of the systems take into account that there are numerous people with numerous agendas, wants and desires in the world—so each person must have the ability to view their own customized augmented reality.

US Patent Publication No. 2009/0237328 for a Mobile Virtual and Augmented Reality System, by Gyorfi, et al., published on Sep. 24, 2009, teaches a method of using a database which is user modifiable so a user can place “graffiti” as an augmented view in a particular location. Gyorfi's invention does not, however, take into account how 3d objects could be created for a particular location, how objects are seen from different views of the same location, how users could choose or not choose to see particular augmentations of a particular location. Further, Gyorfi's invention is purely an “image overlay”—a user doodles and that image then gets placed over the visual image from the third party database. That means the “tag” has limited dimensional data (or properties) and no provisions or design ability to allow any user to create the user's own abstractions for the user's own unique applications.

U.S. Pat. No. 6,317,127 for a Multi-user Real-time augmented Reality System and Method, by Daily et al. granted on Nov. 13, 2001, teaches a high resolution real-time multi-user augmented reality system that broadcasts a wide FOV video signal from a plurality of users that independently select and view different portions of the video signal such that the angular resolution of the displayed video signal is constant over the range of possible viewing orientations. Daily et al.'s patent describes a viewing method which is compatible with the current invention. Further, Daily et al.'s patent does not teach how to create a database to store the augmented views and make same available to anyone via any type of viewer.

Accordingly, there is a need for a system by which users may view different virtual reality feeds (20) at different times based on their location, the time of day, their preference of what feed should take precedence over another feed or should be shown at the same time as overlays. In addition, there is a need to allow the users to allow numerous other filters to AR feeds (20). Also, there is a need for a method whereby 2D and 3D augmentations may be placed at locations and are modifiable by 3rd parties, depending on the AR feed.

### SUMMARY OF THE INVENTION

The present invention allows people to experience media that others have tagged (placed) at particular tangible locations in the physical world, within particular views and associated with a particular Augmented Reality Feed (ARF) using a cell phone or online directly on a map (one method would be to allow it to be a Google™ app as an add on to Google's™ Street View).

An Augmented Reality Feed (ARF) is similar to the concept of a news feed in which there are an unlimited number of feeds (20) and users may create feeds (20) at will. Some feeds (20) will be used extensively, and others not at all. Some feeds (20) will have specific purposes, or may be governmental and are modifiable by only a particular agency—ex. electrical lines—and others could be modifiable by anyone—ex 12 year old art project. Each user will have the ability to choose what feeds (20) their augmented reality device ‘sees,’ and displays to the user.

Accordingly, this is a method of allowing people to be able to see 2D or 3D objects that are placed in a virtual environment via a portable viewing device such as a cell phone or a heads up display. For example, a historical placard (or analogous information system if one is even present) is replaced or augmented by a virtual information system. Likewise objects or locations not previously provided with such placards may have one created for it. A historian could add depth of information not available at the time the placard was created, or provide a much more expansive history of the object or location. A conspicuous tree on a trail could be tagged with an “I was Here” tag by each visitor, possible on a virtual placard specifically intended for that purpose, similar to a guestbook. Such information could be indexed by various factors such as the location the person resides. Similarly, the guestbook could exist in a virtual environment, aided by a desk to write on. Such a 3D tag would require a 3D environment to be displayed within an augmented reality view.

Objects and the information to which it is being associated (tags) need not have an absolute position in space. For example, a ferry boat or train moves in a limited confined space; and thus, there are limited ambiguities when looking towards or standing on the ferry entry area or the train's track. The information associated with an object also need not be “fixed”; for example the schedule and pricing for the ferry and train is likely fixed however the initially presented information would likely be presented as the schedule at that moment (next arrival/leave time and price) the data is fixed but indexed by time. Likewise, when querying the object's information, the user's information may also be passed such as vehicle size for ferry pricing, or the users train pass number so as to provide the fee associated with their account versus an on demand ticket buyer. Dynamic index rules would relate to travelers, say on vacation, or consumers who might declare they are looking for a specific item; and thus, the present invention displays the stores in the mall that the user has just entered—and information such as whether a store has a desired item, the desired item's price, and perhaps even the time delay for checking out of the store (the estimated wait time for the physical queue to checkout).

It should be noted that the user “pulls” the desired associations versus being “pushed” onto them. A store can't force anything onto the users display device (likely a cell phone) that the user is not looking for at that moment, nor has an “open request” to be alerted to. A user would make such an open request by ‘tuning” to the stores channel details of which are described below. The preferred method for a user to tune to the stores channel would be for the user to have an app on their phone (or other augmentation viewing device) that would note when the user enters the store and it would automatically tune the user to the store's channel. Such an app could do other things, such as letting the user know when he or she passes a monument designed and made by a specific person, or in the previous example, determine the ferry pricing without having to ask or any other information request imaginable by the user. The latter example also conveys the ferry's lower costs by embracing the system and keeping the provided information up to date, no printing fees or updating signs in multiple locations. There, of course, can be a Security layer to allow, for example, family members to add data to items and secure those items to other family members based on passwords. Subscription services could also be implemented the same way. The same information would also, of course, be available to the store owners, those that control the parks and ferry boats and would dictate said institutions pertaining to what information is desired and not desired by the people through the use of the institution's AR feed.

All information provided to a user in a particular AR feed could be in 2D, 3D or 4D or a combination thereof. In order for 3D information to be placed into the system, a 3D environment, such as Opensim, will be the preferred method. It is possible for some to use a different 3d object creator and place it in the database using 2D tools, but such would require far more technical skill and, as such, it is not preferred.

The tagging method is where, in a 3D environment, prim (a prim is the basic building block as defined with in most 3D environments) and non prim objects are given an extra property that can hold metadata defined by the user. In a 2D format text and pictures can also be tagged with the same information. Metadata is included in all objects, textures, audio, etc. This information is then made available to a database. This allows the person using the portable device to see the object when running an application that accesses the database based on the information placed by the creator of the object in the 3D environment. (This also allows for any tagged object to be searched via conventional database queries and search methods.) Alternative methods for objects to be placed into the AR database are: through access to a webpage where the user may choose the particular feed desired, the location along with the desired views and then place the information for that location directly into the database; the ability for users to use apps on their cell phones to port audio, video, still photographs, tweets, and any other type of media or system format into a particular feed or feeds (20) depending on the user's preferences.

### BRIEF DESCRIPTION OF THE DRAWINGS

FIG. 1 outlines the relationship between the AR feeds existing within the AR database, and the Viewer API and the Editing API.

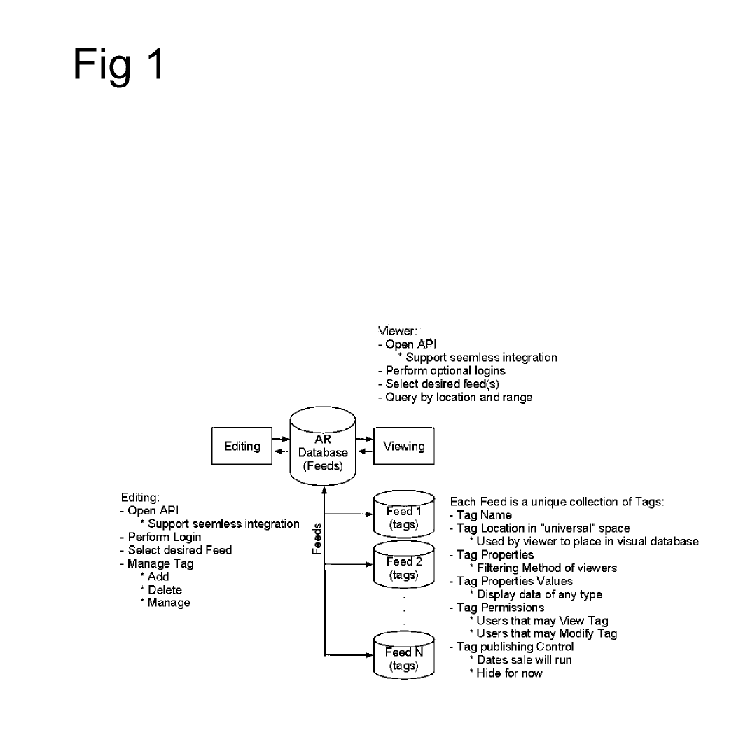

FIG. 2 is a flow chart that displays a broad view of the data flow of the present invention.

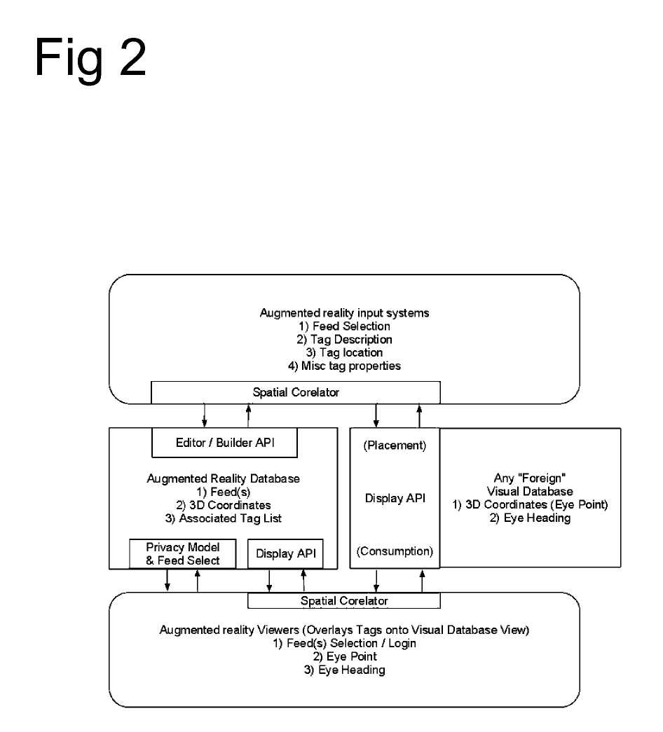

### DETAILED DESCRIPTION

The present invention relates to an elaborate, advanced augmented reality system, configured to display tags as text, 2D graphics, audio, and video, as well as 3D objects necessarily exhibited in a 3D virtual environment. The present invention expands beyond the initial concept of augmented reality by introducing a virtual, three-dimensional element, both in the realm of tagging physical, real-world items and locations with a three-dimensional, virtual tag, and in the virtual realm of tagging virtual-world items and locations with three-dimensional virtual tags contained within the virtual world. The present invention enables the user to view multiple augmented reality streams simultaneously, also known as feeds (20) or, more commercially, channels, each depicting an alternately augmented reality based on the same location and item data (which is preferably coordinately based), housed in a database, connected to a secured server computer.

The augmented reality feeds (20) the present invention provides are preferably designed to be displayed on mobile devices, especially smartphones and tablet computers. These devices preferably maintain the capacity to display multiple different views of the ‘world’ (be it virtual or physical) as they are presented by the authors of the feeds (20). Additionally, avatars as well as other personal data may be tagged to an individual's location via their cellphone or GPS signal, which may then be seen in augmented view from the perspective of another.

At least four views of the world will be available:

1. Street view

2. Search view

3. Mixed Street and search with two panels on the screen

4. 3D view available when inside a virtual environment or when using a 3D enabled device.

Tagging locations in the real world is accomplished by a user either by:
(a) tagging a location view by taking a photograph using the app on the cell phone that tags the x, y, z location (based on data from multi-axis sensors held within the device, including but not limited to a compass, gyroscopes, and accelerometers) as well as the direction faced. Using this method, the photograph does not have to be used. The photograph is the method by which we identify the view. The user can then record audio to be tagged at the spot, type text to be overlaid on the spot and then choose where that overlay or audio tag is going to be seen by other users.
(b) tagging a location via Google Street View TM and using the resulting location information;
associating tagged spots to:
(a) types of feeds (20), including but not limited to user-created feeds, group feeds, public feeds, private or corporate feeds, paid feeds, hobbyist or enthusiast feeds, event feeds (such as at a NASCAR race, and the tags shown in augmented view are displayed as though they were above the race cars), etc. (b) a sub-set of the feed to a particular location
a tagged object placed at that location by a user which can be:

1. text

2. 2D Graphic

3. 3D image located in a 3D environment (a specific format to tag a 3D image to a particular feed must be arrived at that will be standard across the board)

4. Audio

5. Video

6. Information in any other format (ex. database format, machine viewable, and combinable with other information)

7. a combination of any or all of the above

In general, since the data entered, and interacted with, is based on physical spatial location, current geo-spatial database owners must have such fundamental KEYs as part of their database and those keys are how any user (public or private) must interact with their database. This then means that the database owner may also include the present invention as a component or feature of their database or service. However, this also implies that the database owner cannot possibly prevent others from creating a separate, independent database that adds the present invention's data associations to that “3rd party” geospatial database.

Patent Benefits

It is the intent of the present invention to function as both as a robust management tool of data associated with physical locations, as well as to empower users with the capacity to utilize other suppliers' geospatial database for their own unique needs. In the later case the Augmented Reality user is empowered to leverage the geospatial databases of others to satisfy their own needs. The AR user thus has zero costs to build, manage, or maintain the geospatial database in the face of new roads or any other terrain or development changes. Many such geospatial databases are available for free, thus absolutely minimizing cost of implementation, but still allowing use of any other geospatial database (paid or not), as coordinate data is readily and easily mapped from one database to another. The concept of longitude, latitude and elevation are such entrenched and ubiquitous standards that the AR system could, in fact, be used to add tags (70) to unreal or virtual worlds such as today's Second Life, Spoton3D, Opensim or any other virtual world. Even a contrived virtual world can still be comfortably mapped into longitude, latitude, elevation coordinates. Therefore, the scope of the present invention's application is not solely limited to implementation in the physical world, but is intended to be equally effective when implemented in a virtual, 3-dimensional environment.

Viewer API

Since mobile usage is expected to be the primary use of the device, today's ubiquitous Internet connectivity of mobile devices would serve as the connection layer of the AR system. The AR system will succeed by having many users contribute to the AR database and not competitor systems or databases. History solves this happens when users are provided the ability to directly access such system at the lowest level possible and thus author their own applications, or author applications on behalf of a select group of users. This also allows the AR owner to focus on the AR system while others expand resources to adapt the system to all possible users. With that goal in mind the preferred embodiment would preferably employ standard HTTP/HTTPS query encoding. HTTP or HTTPS queries would be allowed for all tags. HTTPS would be optional if a user wishes to optionally encrypt their queries and responses for security. Responses are then returned using the same protocol as the query (standard website analogous behavior). Allowing optional use of HTTP and HTTPS also allows inexpensive devices incapable of HTTPS protocol (computationally very expensive) to have full access to public and private tag feeds. Users allowing unencrypted use of their feed logins accept responsibility for possible leakage of their feed's login information. The most basic query would be of the form, assuming the AR server has an address of EXAMPLE.COM (components are separated into separate line for easier reading and discussion):

http://example.com/viewer
?feed=[name]
&username=[name]
&password=[password]
&longitude=X.X
&latitude=X.X
&elevation=X.X
&radius=X.X
&format=[XML|JSON]
&search=[Property:Value]

The optional search parameter provides a mechanism to simplify the viewer and user's task of filtering or sorting through feed data while also minimizing server load and data transfer latencies. In other words, allow the viewer to find desired tags without having to download all tags to search for ones of interest. The search parameter takes advantage of the implied XML property value pairs and requests the server only return tags for which the XML or JSON data contains matching pairs. The server will automatically expand the query across vectors in the XML or JSON data. Values may also be specified using standard boolean notation, including ‘greater-than’ and ‘less-than’ constructs.

The search parameter only has scope of the specified feed, although it should be noted that global search parameters will eventually be implemented; however, this would have to be performed on a second server, equipped with full indexing.

Where “X.X” indicates a signed decimal number in meters and has the number of significant digits to properly define the desired location. The user name and password fields must supply the login information for private feeds. Public feeds do not require these fields to be supplied since they have no login information for viewing. Feed parameter selects the desired feed being queried. The Longitude, Latitude, Elevation and Radius fields design a sphere within which the client is asking the full tag contents of. That is all tags defined in the sphere will be returned, however the server may reduce overhead by reducing the sphere's radius and will send back the sphere radius it used to provide the tag list response. The format parameter allows the client to select the response format; XML (Extensible Markup Language) or JSON (JavaScript Object Notation). The exact properties and value formats used in responses are defined by the feed's creator and owner. This is the purpose for which XML and JSON exist, to allow a standard conversation framework, but the details of the encapsulated data is free form. Thus allows each user to build tags as needed without having to shoehorn nonsensical “standard” formats. Over time user will define some standard formats but user will adapt and modify as needed. The only requirement is that the AR server will preface the XML or JSON with radius and response code values to convey status to caller.

Editor API:

For simplicity the editor API mirrors the viewer API just adding required tag management parameters:

http://example.com/viewer
?feed=[name]
&owner_name=[name]
&owner_password=[password]
&email=[emailaddress]
&operation=[add|delete|modify|all]
&longitude=X.X
&latitude=X.X
&elevation=X.X
&tag_name=[name]
&tag_password=[password]
&tag_scope=[public|private|hidden]
&tag_permission=[readonly|readwrite]
&tag_value=[XML|JSON]

One method for creating a feed: The email parameter is a one time use parameter to create new feeds (20). The results of using this parameter is the AR server's transmission of an email to the person requesting the feed, and to identify them using an email address. A link with CAPTCHA is then used to confirm a human is creating the feed, helping to verify the user's identity. The email can then be used for billing, legal, and general accountability of the user and user account.

Since the value parameter may be very large, the client may send the above query as an HTTP “get” or “post” command. Since feeds (20) carry the concept of an owner, User-name and Password fields are always required for full tag management. The scope fields allow the owner to make tags public (viewable by all), private (viewable only by those with the tag's password and feed user-name), or hidden to allow the feed owner to have tags they are working on but are not yet ready to be published. The tag permission field allows the feed owner to allow others to modify the tag. The same editor command is used by the 3rd party wherein the owner_name and owner_password are set to equal to the tag_name and tag_password previously provided to that user. Third party users are thus only empowered to perform a ‘modify’ operation, not add or delete, nor change the scope or users' permissions. The operation is a very special case, and excessive use of this command will be frowned upon and possibly cause closure of the feed and the banning of the owner from further database access. The user uses this command, without any tag parameters, to receive a complete list of all tags in the feed. This is the method by which the local editor application can re-sync with the contents of the AR database. Thus this is an infrequent management tool and not a real time tool. Since so much overhead is incurred by its use, it's only used infrequently.

Some Viewing Methods

There are a number of methods to view the augmented views listed herein, however these are not the only methods, merely the suggested methods at this time.

1. cell phone
a. hold up the cell phone and view the regular world with the augmentation overlaid on the regular world view via the rear-facing camera mounted on most conventional cell phones, especially pertaining to smart-phones. Multiple overlays (also known as channels or ‘feeds (20)’) may be exhibited simultaneously on a user's cell phone or other mobile device. Additional channels may be displayed as layers overtop one another, or may be easily toggled on and off at the user's request. Rather than simultaneously, user's have the option of viewing a single channel or feed pertaining to a specific location (rather than all at once), and then may change between available, public feeds at will.

2. online
b. view of the world at the location chosen in the direction chosen. Any number of views can be overlaid when on a high-speed connection.

Avatar tagging—This is where someone has the capacity to, be it in a single feed (40), all feeds, or other user-selected feeds, either substitute their own personal real image (PRI) for that of an avatar, or overlay their own PRI with tags that follow them based on their location. This allows people to join societies and for other people to be able to recognize others within their society. Example: All people in the society, which can only be joined by another person who is already a member inviting the new person and everyone in the society being allowed to vote on that person's acceptance thus allowing the party's signal to ‘float’ above that person's head.

Hardware:

Hardware, including, but not limited to monitors, TV screens, and projection displays, could be configured, when connected to the secured server and network (including databases), to display AR content in the physical world (such as in store fronts, malls, and restaurants). This AR content could include the capacity to configure the display such that it would show individuals, similar to a mirror, as they walked into the store, only instead of an exact physical reflection as in a mirror, the monitor would display the individual's avatar. If the monitor is equipped with a camera as well, the avatar of the individual may be overlaid onto the camera stream feed, and displayed as a whole on the monitor. It can be envisioned that other information, including tags, affiliations, and other content would be visible within the display as well. The proprietor of the store could assign additional functions to the server and network-connect monitor including functions specific to that store's channel or feed. This could include advertisements or announcements, as well as other data. More private viewing will require glasses, preferably with flip-down lenses and equipped with a switch to toggle an ‘augmented view’ on and off. These glasses would function similar to the monitors, and would detect proximal AR tags and other metadata and overlay them on top of the user's conventional, unaided vision. Still, the primary hardware used initially with the AR system include portable electronics, including but not limited to cell phones, smartphones, tablet computers, netbooks, etc.

### Alternative Embodiments

It is also envisioned that, to address issues of disambiguation, objects might have attached “barcodes”

(1D, 2D, or beyond) to uniquely mark them for better and easier integration to the association system.

The geospatial database owner would likely want to provide the invention so as to simplify use by specific users or to add revenue generation services. An example might be to provide local utilities a service where the maps of their property (including service poles, buried wires, and water or gas pipes) are placed over the geospatial map, in effect allowing their cell phones (upon authorized login) to provide the effect of “x-ray vision” enabling the augmented, virtual view of underground pipes and wires, or to visually identify (perhaps by red highlighting) the specific pole wires that need servicing. In other words, the geospatial database owner provides subscribers a paid service that provides employees access to all required maps in real-time but saving them the time-consuming task of finding the right maps and objects being pursued on them at any given moment.

Databases created by individuals and organizations independent of the geo-spatial database “owners” will also present a huge opportunity to provide systems that address areas for which there may be no marked forces which naturally bring users together in an easy-to-organize fashion. In effect, the implementation of the invention itself becomes the method by which users come together and become organized. To be clear, there is no need for solely a single instance of the invention, and competing instances are expected so as to allow and force evolution in the space of the present invention, and the realm of augmented reality. More importantly such implementations are naturally independent of the geo-spatial database they are initially associated with, since the integration point is a location in three dimensional space (and standard viewpoint of mankind) any geospatial database may be exchange with another at any time or multiple such databases may be available simultaneously (each providing it's own unique benefits).

Private feeds would be created by institutions with proprietary data. Institutions could then charge for access to this data, or could sell advertisements that would be placed along side the proprietary data. Such advertisements would be sold in a similar fashion as currently done by Google™ and Yahoo!™, except it would allow the advertiser to not only provide the key words, but locations where they do and do not want to advertise in 3D. This of course could be integrated into the same database as the one which allows users to create AR feeds (20) and objects in the AR feeds (20).

An optional, human search of the database could be combined with a traditional Internet search in order to allow users to also search for items tagged based on the a list of all tagged items, the location, key words, image search, audio search. The search may be integrated into any other search system with the added benefit maintaining access to all of the API options, as well as boolean options, coded into user-friendly options at the top, available at the will of the user, if the user wishes to see these advanced options, similar to Google's advanced search, but with many more in-depth options. Multiple levels of this search should be presented to the world so that a search that takes time to do would be delivered to the user via a link in an email or text message as they choose, or, if the user wishes to pay for the search to be done faster, then they may add on a small payment for increased cpu power and speed (adding on computers via cloud computing—ex Amazon) plus a small fee for the company. An estimated Search Speed should appear in the top right of the screen when a search is complicated enough to not be instantaneous, providing the estimated time remaining until the search's completion. It should be understood that the present invention is an augmented reality method, comprising the steps of a computer receiving information from a user; the computer associating the information with an object; and the computer displaying the object to the user, the object represented on a geo-spatial database according to the information. Also, the present invention is an augmented reality method, comprising the steps of a computer receiving information from a user; the computer associating the information with a location; and the computer displaying the location to the user, the location represented on a geo-spatial database according to the information. The present invention has the information is chosen from the group: text, images, audio, video. The object and/or object is not accessible in a publicly accessible geo-spatial database. The object and the geo-spatial database are associated with a virtual world. The location and the geo-spatial database are associated with a virtual world. The computer tunes to a channel that provides information overlayed on the geo-spatial database. The computer tunes to a channel that provides information overlayed on the geo-spatial database. The computer receives a channel displayed on the geo-spatial database, the channel modified by an authorized user. The computer receives a channel displayed on the geo-spatial database, the channel modified by an authorized user. The computer receives a channel displayed on the geo-spatial database, the channel only viewable by an authorized user. The computer receives a channel displayed on the geo-spatial database, the channel only viewable by an authorized user. The computer correlates a search engine with the geo-spatial database, the search engine searching for meta data for a particular object at a particular position in the geo-spatial database. The computer correlates a search engine with the geo-spatial database, the search engine searching for meta data for a particular location at a particular position in the geo-spatial database. The

We claim:

1. An augmented reality method, comprising the steps of:
a computer receiving information from a user;
the computer associating the information with an object; and
the computer displaying the object to the user, the object represented on a geo-spatial database according to the information.

2. An augmented reality method, comprising the steps of:
a computer receiving information from a user;
the computer associating the information with a location; and
the computer displaying the location to the user, the location represented on a geo-spatial database according to the information.

3. The method of claim 1, wherein the information is chosen from the group: text, images, audio, video.

4. The method of claim 1, wherein the information is chosen from the group: text, images, audio, video.

5. The method of claim 1, wherein the object is not accessible in a publicly accessible geo-spatial database.

6. The method of claim 2, wherein the location is not accessible in a publicly accessible geo-spatial database.

7. The method of claim 1, wherein the object and the geo-spatial database are associated with a virtual world.

8. The method of claim 2, wherein the location and the geo-spatial database are associated with a virtual world.

9. The method of claim 1, further comprising the computer tuning to a channel that provides information overlayed on the geo-spatial database.

10. The method of claim 2, further comprising the computer tuning to a channel that provides information overlayed on the geo-spatial database.

11. The method of claim 1, further comprising the computer receiving a channel displayed on the geo-spatial database, the channel modified by an authorized user.

12. The method of claim 2, further comprising the computer receiving a channel displayed on the geo-spatial database, the channel modified by an authorized user.

13. The method of claim 1, further comprising the computer receiving a channel displayed on the geo-spatial database, the channel only viewable by an authorized user.

14. The method of claim 2, further comprising the computer receiving a channel displayed on the geo-spatial database, the channel only viewable by an authorized user.

15. The method of claim 1, further comprising the computer correlating a search engine with the geo-spatial database, the search engine searching for meta data for a particular object at a particular position in the geo-spatial database.

16. The method of claim 2, further comprising the computer correlating a search engine with the geo-spatial database, the search engine searching for meta data for a particular location at a particular position in the geo-spatial database.

17. The method of claim 1, further wherein the geo-spatial database has data, the data indicating the way to make a 3D object viewable in real world via an augmented reality viewer.

18. The method of claim 2, further wherein the geo-spatial database has data, the data indicating the way to make a 3D location viewable in real world via an augmented reality viewer.

19. The method of claim 1, further comprising the computer filtering to allow multiple channels to be displayed on the geo-spatial database at the same time.

20. The method of claim 2, further comprising the computer filtering to allow multiple channels to be displayed on the geo-spatial database.
